(19) United States
(12) Patent Application Publication
(10) Pub. No.: US 2021/0032906 A1
(43) Pub. Date: Feb. 4, 2021

(54) SECURITY TETHERS FOR SECURING PERSONAL PROPERTY

(71) Applicants: Joshua D. Putman, Estacada, OR (US); Colin Preston, Oregon City, OR (US)

(72) Inventors: Joshua D. Putman, Estacada, OR (US); Colin Preston, Oregon City, OR (US)

(21) Appl. No.: 16/528,258

(22) Filed: Jul. 31, 2019

(51) Int. Cl. E05B 73/00; E05B 15/16

(52) U.S. Cl. CPC E05B 73/0005; E05B 71/00; E05B 15/16

(57) ABSTRACT

Security tethers for securing personal property near an entryway, the entryway including a frame with an inside portion and an outside portion, a door supported by the frame and configured to open and close, and a gap between the door and the frame. The security tethers include an inner plate disposed on the inside portion of the frame proximate the gap, a tether coupled to the inner plate and including a first end and a second end opposite the first end, wherein the tether passes through the gap between the door and the frame, and an attachment member attached to the second end of the tether.

### BACKGROUND

The present disclosure relates generally to security tethers. In particular, security tethers for securing personal property are described.

Securing personal property is necessary to resist and avoid personal property being taken by thieves or others who might move property to another location without permission. Personal property commonly benefiting from being secured includes packages, bicycles, and mobile electronic devices, just to name a few.

People often need to secure personal property outside entrances to their homes or businesses. For example, people need to secure packages delivered while the owner is not present and need to secure bicycles near an entrance when bicycles are not permitted inside or there is not room to store them inside. Package deliveries are increasingly common as ecommerce becomes increasingly utilized. Unfortunately, theft of packages left outside entryways by delivery persons is increasing as well.

Conventional methods of securing personal property take many forms. Some methods involve lock boxes or other secure enclosures. Some attempted solutions have required homeowners to grant permission to delivery drivers to enter their homes while they are away, which raises concerns about privacy and security. Other methods use rigid locking members, such as U-locks, to secure personal property to a structure. Another method uses tethers, such as cables and chains, to secure personal property to structures.

Known security tethers are not entirely satisfactory for the range of applications in which they are employed. For example, existing security tethers must be wrapped around a structure to work effectively. Needing to wrap around a structure limits where the security tethers can be used. In particular, conventional security tethers are not well suited to use outside a entryway because there typically is not a structure around which to wrap the security tether.

Conventional solutions to secure personal property near entryways are not ideal or convenient. Most conventional solutions require modifying the entryway or surrounding structures in some fashion to work. Other solutions, even if not requiring the entryway to be modified, tend to damage entryways, such as by scuffing, scratching, or denting the entryway.

Modifying or damaging entryways and other structures can be inconvenient, expensive, or not allowed under one's lease or governing rules and regulations. Solutions that require modifying entryways and/or surrounding structures also tend to be permanent or semi-permanent, which can be unattractive or unwanted when securing personal property is not needed.

Thus, there exists a need for security tethers that improve upon and advance the design of known security tethers. Examples of new and useful security tethers relevant to the needs existing in the field are discussed below.

### SUMMARY

The present disclosure is directed to security tethers for securing personal property near an entryway, the entryway including a frame with an inside portion and an outside portion, a door supported by the frame and configured to open and close, and a gap between the door and the frame. The security tethers include an inner plate disposed on the inside portion of the frame proximate the gap, a tether coupled to the inner plate and including a first end and a second end opposite the first end, wherein the tether passes through the gap between the door and the frame, and an attachment member attached to the second end of the tether.

### BRIEF DESCRIPTION OF THE DRAWINGS

FIG. 1 is a side view of a security tether and an entryway providing access to a dwelling, the security tether is cooperating with the entryway to provide a tether to secure an item of personal property outside the dwelling.

FIG. 2 is a rear elevation view of the security tether shown in FIG. 1 from a position inside the dwelling depicting an inner plate spanning a gap between a door and a frame.

FIG. 3 is a front elevation view of the security tether shown in FIG. 1 from a position outside the dwelling depicting the security tether coupled to a locking device securing a personal property item.

FIG. 4 is a close up view of the security tether shown in FIG. 1 depicting the tether compressed between the door and a doorjamb to hold the tether in place when the door is closed.

FIG. 5 is a perspective view of the security tether shown in FIG. 1 with a portion of a sheath covering the tether removed to reveal the tether obscured behind the sheath.

FIG. 6 is a front elevation view of the security tether shown in FIG. 1 from a position outside the dwelling depicting the guide on the tether in a first position distal the entryway.

FIG. 7 is a close up perspective view of a second embodiment of a security tether cooperating with an entryway providing access to a dwelling from a vantage point inside the dwelling, the security tether including a ratchet mechanism secured to the entryway inside the dwelling.

FIG. 8 is a is a rear elevation view of the security tether shown in FIG. 7 from a position inside the dwelling depicting an inner plate pulled tight against an edge of a frame of the entryway by the ratchet mechanism.

FIG. 9 is a front elevation view of the security tether shown in FIG. 7 from a position outside the dwelling depicting a catch plate pulled tight against an edge of the frame of the entryway by the ratchet mechanism.

### DETAILED DESCRIPTION

The disclosed security tethers will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various security tethers are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Entryway

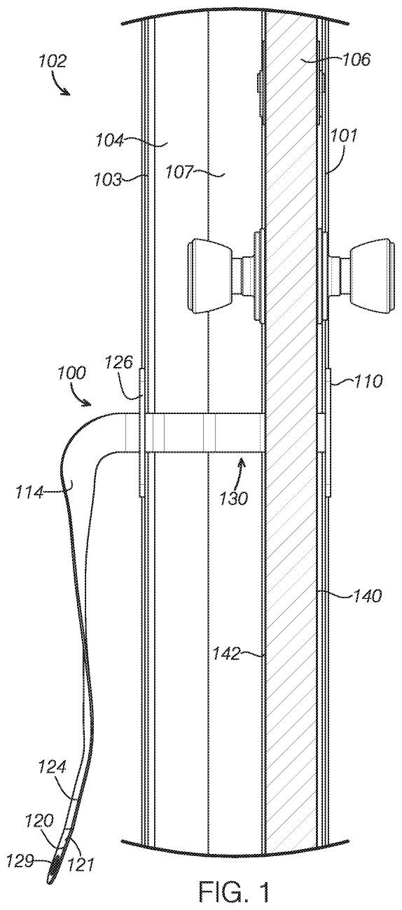

The features of an entryway 102 shown in the figures will first be described to aid the discussion of the security tethers disclosed herein. This discussion will refer to entryways and doorways synonymously. As can be seen in FIGS. 1-4 and 6, entryway 102 includes a frame 104, a door 106, a doorjamb 107, and a gap 108. In other examples, the entryway may include fewer or additional features. The security devices described herein may be used with any currently known or later developed entryway.

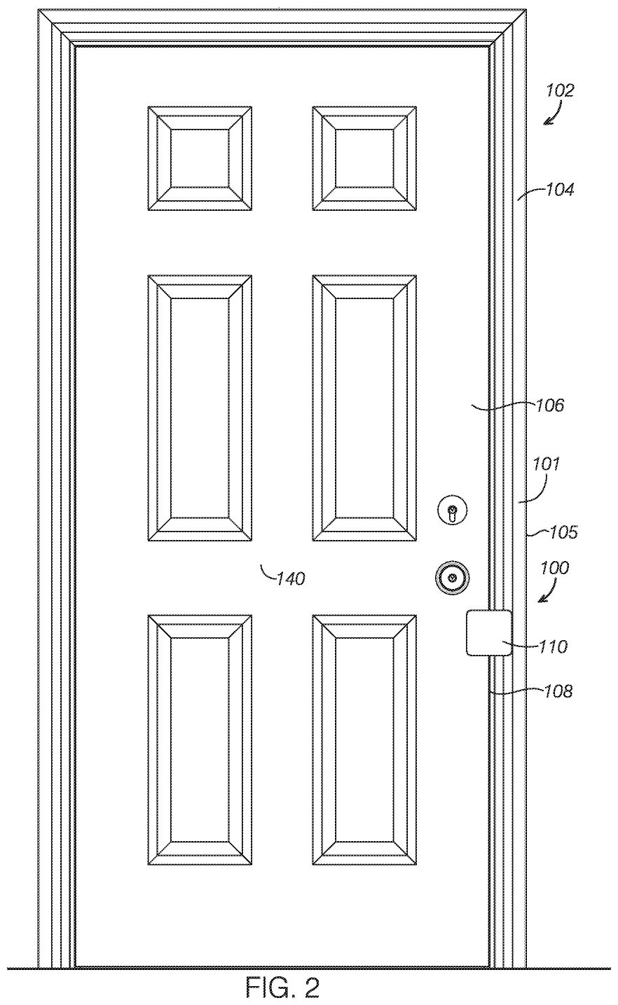

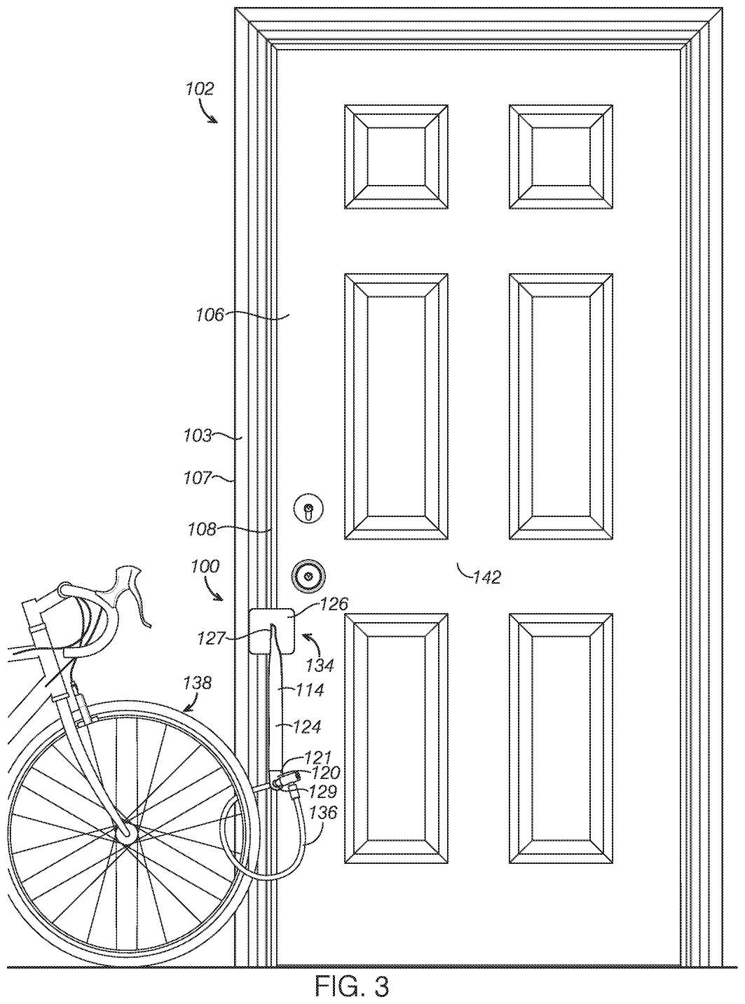

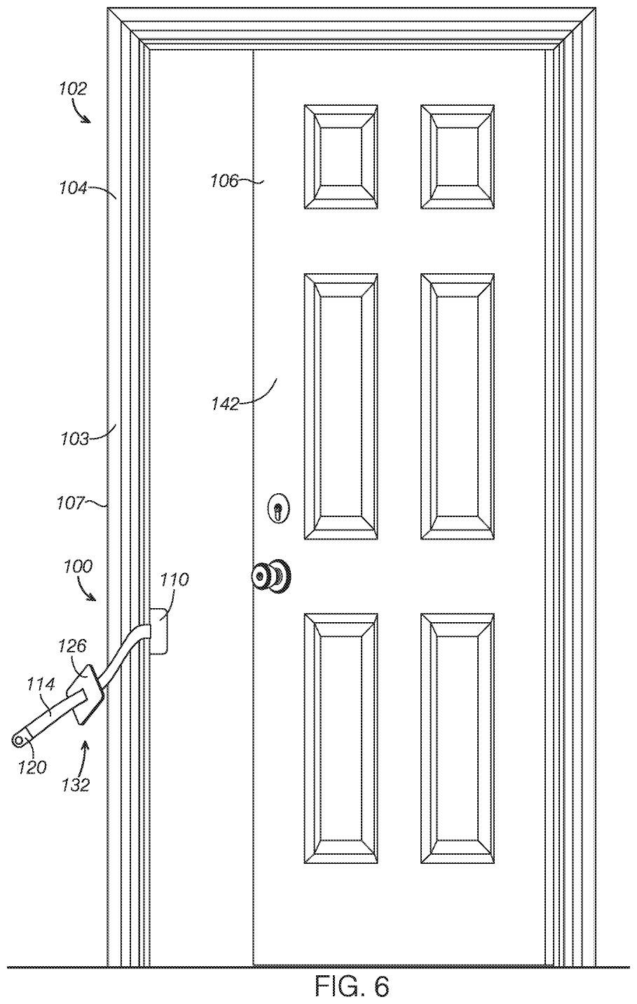

Entryway 102 is a conventional entryway used to provide access to a dwelling. In the discussion herein, the term dwelling is not limited to residential settings, but includes any space, whether residential, commercial, industrial, or governmental, accessible through an entryway. The entryway could be installed on the exterior or interior of any type of building, such as an apartment building, a freestanding home, or a commercial establishment. In the figures, FIG. 2 is a view of entryway 102 from inside the dwelling and FIGS. 3 and 6 are views of entryway 102 from outside the dwelling.

Frame 106 includes an inside portion 101 disposed inside the dwelling and an outside portion 103 disposed outside the dwelling. Inside portion 101 of frame 104 includes an inside vertical edge 105 distal gap 108. Correspondingly, outside portion 103 of frame 104 includes an outside vertical edge 107 distal gap 108.

In the examples shown in the figures, frame 104 is depicted including ornamental moldings covering a structural frame supporting door 106. Moldings are not always present, required to support the door, or required for the security tethers to work properly.

Door 106 is supported by frame 104 and is configured to open and close to provide access through entryway 102. In the present example, door 106 pivots open and closed relative to frame 104. In other example, the door may translate open and closed. Door 106 includes an inner face 140 facing inside the dwelling when door 106 is closed and an outer face 142 opposite inner face 140 and facing outside the dwelling when door 106 is closed.

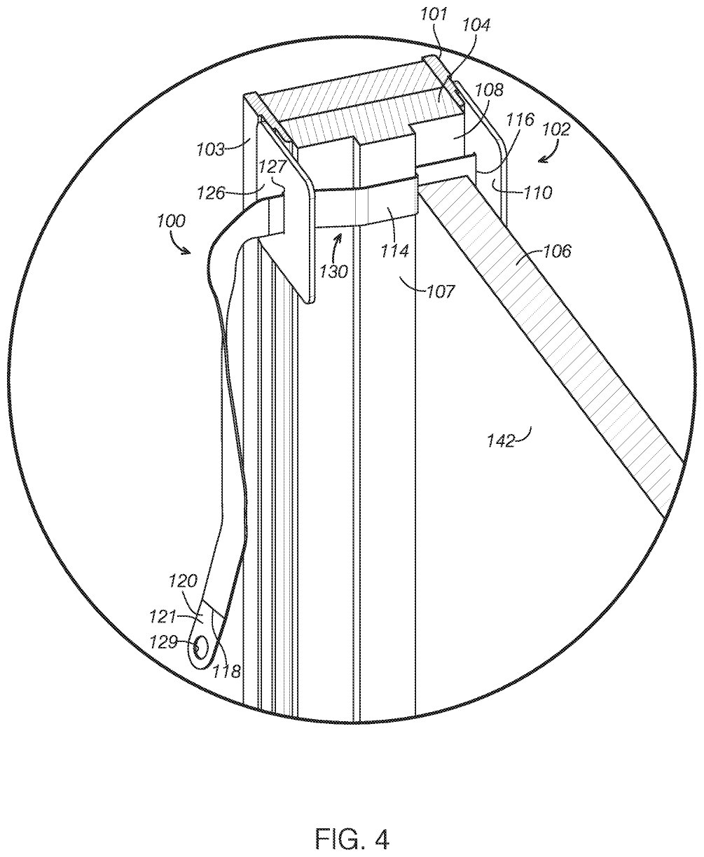

With reference to FIG. 4, gap 108 is defined by the space between door 106 and frame 104. The size of the gap can vary and is usually set by local building codes.

Doorjamb 107 disposed on a portion of frame 104 and projects into gap 108. In conventional fashion, doorjamb 107 restricts the pivotal path of door 106. When door 106 is in a closed position, it resides close to doorjamb 107. In some examples, the door abuts the doorjamb when the door is closed.

Locking Device

As shown in FIG. 3, locking device 136 is a cable lock configured to secure a bicycle. In other examples, the locking device is a U-lock, a padlock, or any other currently known or later developed lock for securing personal property items.

Item

In the example shown in FIG. 3, item 138 is a bicycle. However, the security tethers described herein are configured to secure all manner of personal property items, such as packages, furniture, grills, scooters, and mopeds. In some examples, pets are secured to the security tether via a leash.

Security Tethers for Securing Personal Property

The security tethers described herein function to secure personal property to an entryway without permanently affixing to or damaging the entryway. Unlike conventional solutions that must be wrapped around an existing structure, the presently described security tethers do not need to be wrapped around a structure and are specially configured to secure to entryways. However, unlike known attempts to secure property to entryways, the security tethers described here do not require modifying or damaging the entryway and can be easily removed from a entryway when not needed.

### Security Tether Embodiment One

With reference to FIGS. 1-6, a first example of a security tether, security tether 100, will now be described. Security tether 100 includes an inner plate 110, a tether 114, an attachment member 120, and a guide 126.

In some examples, the security tether does not include one or more features included in security tether 100. For example, some security tether examples do not include a guide.

In other examples, the security tether includes additional or alternative features. For example, some security tether examples include fasteners, wraps, and mounting devices for organizing and maintaining the tether in a desired position near the entryway. Certain security tether examples include locking devices, such as combination locks, U-locks, and the like. In various examples, the security tethers include boxes, containers, or enclosures for securing storing items, such as lock boxes, tamper resistant bags, and chests.

The security tethers described herein may incorporate various electronics to provide additional features. For example, the security tether may include electronics configured to log and/or communicate when personal property was secured with the security tether. The security tethers may additionally or alternatively include sensors configured to detect tampering with the security tether, such as attempts to sever the tether.

Inner Plate

As can be seen in FIGS. 1, 2, 4, and 5, inner plate 110 functions to restrict security tether 100 from being pulled away from entryway 102. As shown in FIGS. 2 and 4, inner plate 110 is positioned inside the dwelling proximate gap 108 between door 106 and frame 104. With further reference to FIGS. 2 and 4, the reader can see that inner plate 110 spans gap 108 when door 106 is closed to restrict inner plate 110 from passing through gap 108.

In the present example, inner plate 110 is not fastened to entryway 102. Instead, inner plate 110 is held in vertical position by tether 114, which is held in vertical position by being compressed between door 106 and doorjamb 107 when door 106 is closed. In some examples, the inner plate includes a fastener, such as a mechanical fastener, a hook-and-loop fastener, a magnetic fastener, or an adhesive fastener, to secure the inner plate to the entryway.

In the present example, inner plate 110 is a rigid plate formed of metal. In other examples, other suitable materials for the inner plate are used, such as wood, plastic, or composite materials. In some examples, the inner plate includes a soft, padded, and/or skid-resistant material or coating facing the door and the frame to reduce the possibility of damaging or marring the door or the frame.

As can be seen in FIGS. 1, 2, 4, and 5, the inner plate is a plate and generally planar. In some examples, the inner plate is body with more pronounced three-dimensionality, such as a block or a wedge. The inner plate may be any suitable size and shape effective to resist passing through the gap between the door and the frame.

Tether

As shown in FIGS. 1, and 4-6, tether 114 is coupled to inner plate 110 and extends through entryway 102. In particular, tether 114 passes through gap 108 between door 106 and frame 104 and is compressed between door 106 and doorjamb 107 when door 106 is closed. In the example shown in FIGS. 1-6, tether 114 is welded to inner plate 110. In other examples, the tether may be riveted or bolted to the inner plate.

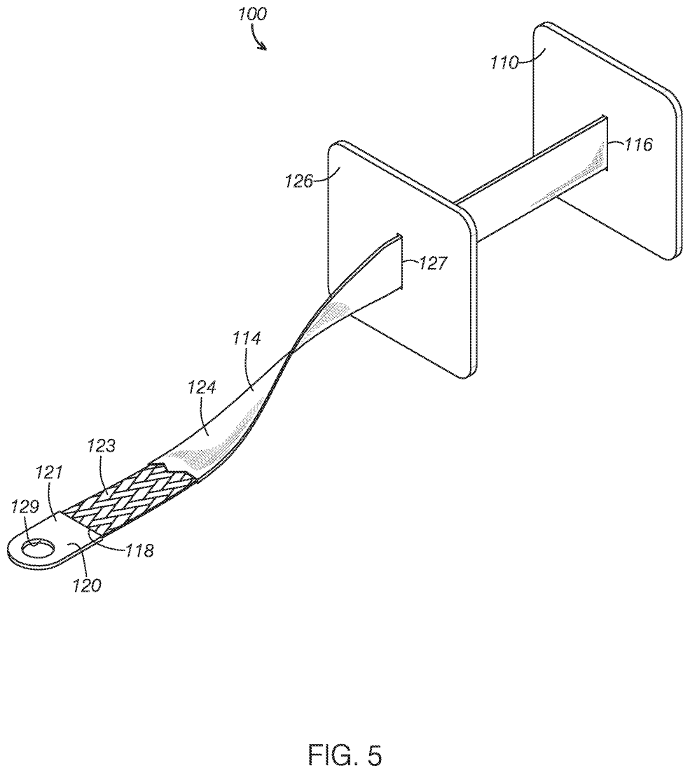

Tether 114 is an elongate tension bearing member functioning to couple a personal property item outside the dwelling to inner plate 110 lodged against door 106 and frame 104 on the inside of the dwelling. Tether 114 is pliable, strong, and resistant to cutting and breaking. As shown in FIG. 5, tether 114 includes a core member 123 and an optional sheath 124 covering core member 123. Some examples of the tether do not include a sheath covering the core member.

Core member 123 and sheath 124 cooperate to resist tether 114 being cut or otherwise compromised. In the present example, core member 123 provides high tensile strength to resist breaking under tension and sheath 124 provides enhanced cut resistance.

As shown in FIG. 5 where a portion of sheath 124 is removed, core member 123 is comprised of woven metal. Woven metal is just one example of a material suitable for the core member. The core member may be any currently known or later developed material suitable as an elongate tension bearing member, such as braided metals, cordage, wires, chains, and the like.

As shown in FIGS. 1, and 3-6, tether 114 includes a first end 116 and a second end 118 opposite first end 116. The length of the tether may be selected to provide a desired amount of coupling reach or range beyond the entryway outside the dwelling. In some examples, the length of the tether extending beyond the entryway on the outside of the dwelling is adjustable. As shown in FIG. 3, tether 114 extends beyond frame 104 a distance sufficient for attachment member 120 to couple with locking device 136 secured to an item 138 located outside the dwelling.

As shown in FIGS. 1, 4, and 5, first end 116 of tether 114 is welded to inner plate 110 and held in place vertically when tether 114 is compressed between door 106 and doorjamb 107. Second end 118 is disposed outside the dwelling in a position where it can reach a locking device or a personal property item to be secured. With reference to FIGS. 1, and 3-5, attachment member 120 is attached to second end 118 of tether 114.

Guide

In the present example shown in FIGS. 1-6, security tether 100 includes optional guide 126 disposed on tether 114 and cooperating with tether 114 to assist with positioning security tether 100 in a desired position on entryway 102. The guide is not included in all examples of the security tether and can be selectively removed from tether 114 in the example shown in FIGS. 1-5. As shown in FIGS. 1, 3, 4 and 6, guide 126 is disposed outside the dwelling on outer face 142 of door 106 opposite inner plate 110 when door 106 is closed.

With reference to FIGS. 3-6, the reader can see that guide 126 is a rigid plate and defines a guide slot 127. With continued reference to FIGS. 3-6, one can see that tether 114 passes through guide slot 127. Guide 126 supports tether 114 in a desired position 130 when guide 126 is held in a position where guide slot 127 is proximate desired position 130. Attachment member 120 and guide slot 127 are complementarily configured such that attachment member 120 is smaller than guide slot 127 to enable attachment member 120 to pass through guide slot 127.

By comparing FIGS. 3 and 6, one can see that guide 126 may move along tether 114 to a first position 132 distal entryway 102 and to a second position 134 proximate entryway 102. Guide 126 is not fastened to entryway 102. Holding tether 114 taut and guide 126 in first position 132 functions to hold inner plate 110 flush against frame 104 and in a desired vertical position when door 106 is open. Tether 114 and guide 126 may be held with guide 126 in first position 132 with a single hand to free one's other hand to open and close door 106. As shown in FIG. 6, guide 126 does not obstruct the path of door 106 in first position 132 as door 106 opens and closes.

Sheath

With reference to FIG. 5, the reader can see how tether 114 is covered by optional sheath 124. Sheath 124 is comprised of a cut-resistant material and covers core member 123. In some examples, the sheath covers just a portion of the core member.

In the present example, sheath 124 is comprised of aromatic polyamide fibers. In other examples, the sheath is formed from other materials, including materials that are cut resistant or wear resistant. Suitable conventional high-strength fiber materials include Kevlar™, Twaron™, Spectra™, Innegra-S™, and Dyneema™.

Attachment Member

Attachment member 120 provides a secure mounting point to which to secure locking device 136. In the example shown in FIGS. 1, 3-6, attachment member includes a rigid tab 121 defining a hole 129. As can be seen in FIG. 3, locking device 136 can selectively extend through hole 129 to secure or link locking device 136 to security tether 100.

In the present example, tab 121 is formed of metal. In other examples, other rigid materials are used, such as hard polymers, composite materials, and wood. The attachment member may be formed of any material and adopt and size, shape, and configuration suitable for securing locking devices to it.

### Security Tether Embodiment Two

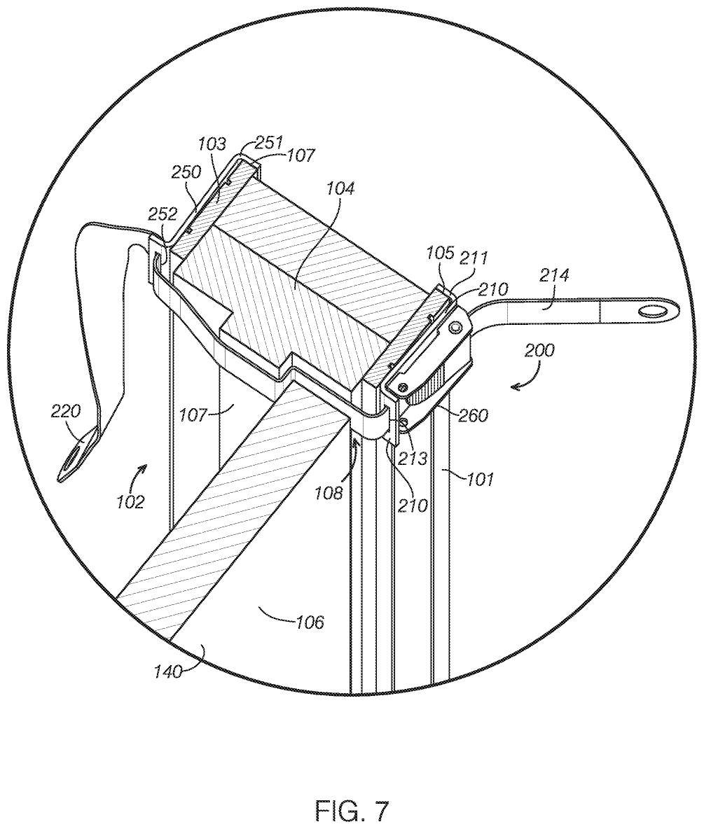

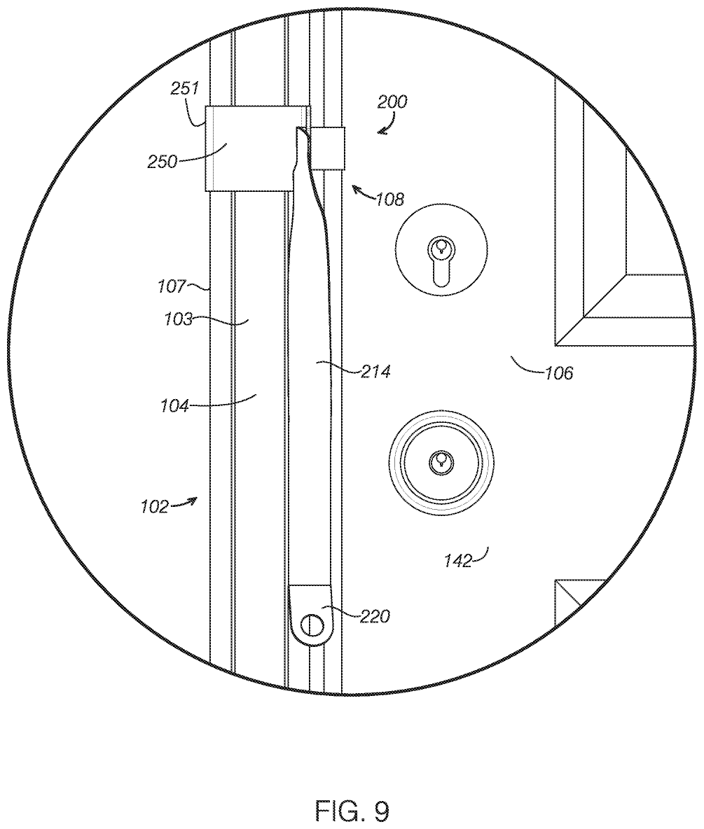

Turning attention to FIGS. 7-9, a second example of a security tether, security tether 200, will now be described. Security tether 200 includes many similar or identical features to security tether 100. Thus, for the sake of brevity, each feature of security tether 200 will not be redundantly explained. Rather, key distinctions between security tether 200 and security tether 100 will be described in detail and the reader should reference the discussion above for features substantially similar between the two security tethers.

Security tether 200 functions to secure to frame 104 of entryway 102 without impeding door 106 opening and closing. As with security tether 100, security tether 200 functions to secure personal property to entryway 102 without permanently affixing to or damaging entryway 102. As can be seen in FIG. 7, security tether 200 includes an inner plate 210, an outer plate 250, a tether 214, an attachment member 220, and a tensioning mechanism 260.

Inner Plate

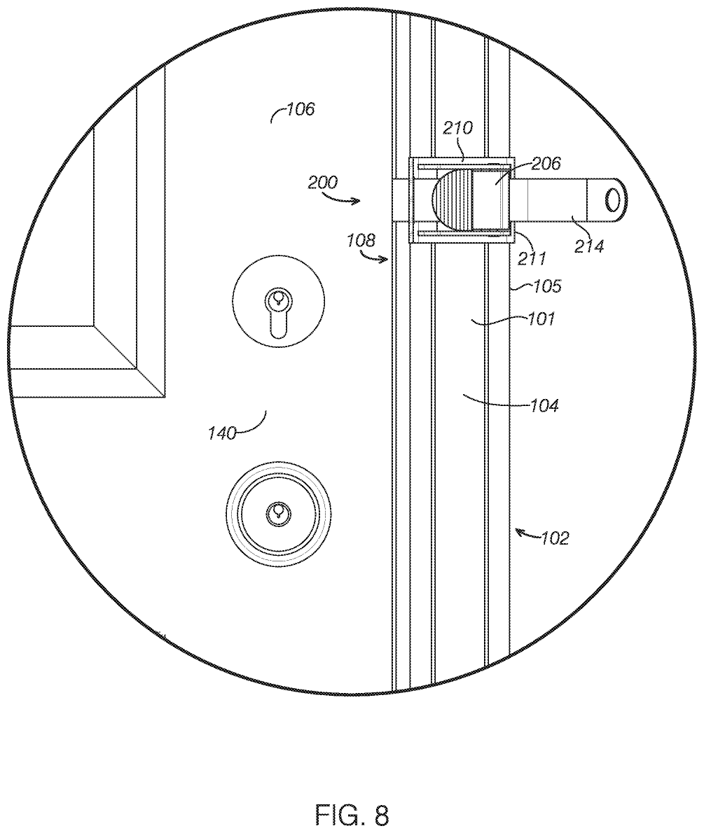

As shown in FIGS. 7 and 8, inner plate 210 is complementarily configured with inside portion 101 of frame 104. Inner plate 210 includes an inner plate lip 211 that wraps around inside portion 101 at inside vertical edge 105 and abuts inside vertical edge 105 to resist inner plate 210 moving towards gap 108. In particular, inner plate lip 211 functions to resist inner plate 210 moving towards gap 108 when tether 214 is tensioned by tensioning member 260.

As can be seen in FIG. 7, inner plate 210 is bent proximate gap 108. The bend proximate gap 108 serves to keep inner plate 210 from impeding door 106 from opening and closing. The bend further serves as a barrier between tensioning member 260 and gap 108 to avoid snagging tensioning member 260 when passing through entryway 102. The bent portion of inner plate 210 defines an inner plate slot 213 through which tether 214 passes.

Outer Plate

Outer plate 250 is configured similarly to inner plate 210 and interfaces with outside portion 103 of frame 104 similarly to how inner plate 210 interfaces with inner portion 101 of frame 104. Outer plate 250 includes an outer plate lip 251 that wraps around outside portion 103 at outside vertical edge 107 and abuts outside vertical edge 107 to resist outer plate 250 moving towards gap 108. In particular, outer plate lip 251 functions to resist inner plate 250 moving towards gap 108 when tether 214 is tensioned by tensioning mechanism 260.

When tether 214 is tensioned by tensioning member 260, inner plate 210 and outer plate 250 cooperate to secure security tether 200 to frame 104. In particular, security tether 200 secures to frame 104 without mechanical fasteners and without damaging or marring frame 104. Tensioning mechanism 260 pulling tether 214 cinches together outer plate 250, tether 214, and inner plate 210 and holds them in place on frame 104. In this manner, inner plate 210 and outer plate 250 are held in place on frame 104 despite not being mechanically or adhesively fastened to entryway 102.

Similarly to inner plate 210, outer plate 250 is bent proximate gap 108. The bend proximate gap 108 serves to keep outer plate 250 from impeding ingress and egress through entryway 102. The bent portion of outer plate 250 defines an outer plate slot 252 through which tether 214 passes.

In the present example, tether 214 is welded to outer plate 250 near outer slot 252 to restrict tether 214 from passing through outer plate slot 252 when pulled by tensioning mechanism 260. By welding or otherwise securing the tether to the outer plate, the tensioning member pulling on the tether functions to pull the outer plate tight against the outer frame.

In some examples, the tether includes a catch on a portion of the tether beyond the outer plate slot distal the tensioning mechanism to restrict the tether from passing through the outer plate slot when pulled by the tensioning mechanism. In some examples, the position of the catch on the tether is user adjustable to accommodate different size door frames. In certain examples, the tether includes multiple catches that can be switched between a catch position and a pass position. In the catch position, the catch cannot pass through the outer plate slot to restrict the tether from passing through it. In the pass position, the catch may pass through the outer plate slot without restriction.

Tensioning Mechanism

As shown in FIGS. 7 and 8, tensioning mechanism 260 is mounted to inner plate 250, which is disposed on inside portion 101 of frame 104. Tensioning mechanism 260 is configured to pull tether 214 towards tensioning mechanism 260. In the present example, tensioning mechanism 260 includes a ratchet mechanism commonly used in ratchet tie down devices. However, the tensioning mechanism may be any currently known or later developed mechanism suitable for applying tension to a strap. In the present example, the tensioning mechanism 260 is manually operated, but in some examples a motor is included to motorize operation of the tensioning mechanism.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A security tether for securing personal property near an entryway providing access to a dwelling, the entryway including a frame with an inside portion disposed inside the dwelling and an outside portion disposed outside the dwelling, a door supported by the frame and configured to open and close, the door including an inner face facing inside the dwelling when the door is closed and an outer face opposite the inner face, and a gap between the door and the frame, the security tether comprising:
an inner plate disposed on the inside portion of the frame proximate the gap between the door and the frame;
a tether operatively connected to the inner plate and including a first end and a second end opposite the first end, wherein the tether passes through the gap between the door and the frame; and
an attachment member attached to the second end of the tether.

2. The security tether of claim 1, wherein:
the inside portion of the frame includes an inside vertical edge distal the gap;
the inner plate is complementarily configured with the inside portion of the frame and includes an inner plate lip that wraps around the inside portion at the inside vertical edge and abuts the inside vertical edge to resist the inner plate moving towards the gap.

3. The security tether of claim 2, wherein:
the security tether further comprises an outer plate disposed on the outer portion of the frame;
the outer plate defines a guide slot through which the tether passes; and
the tether is coupled to the outer plate.

4. The security tether of claim 3, wherein:
the outside portion of the frame includes an outside vertical edge distal the gap;
the outer plate is complementarily configured with the outside portion of the frame and includes an outer plate lip that wraps around the outside portion at the outside vertical edge and abuts the outside vertical edge to resist the outer plate moving towards the gap.

5. The security tether of claim 4, further comprising a tensioning mechanism mounted to the inner plate, the tensioning mechanism configured to pull the tether towards the tensioning mechanism.

6. The security tether of claim 4, wherein the tensioning mechanism pulling the tether towards the tensioning mechanism cinches together the outer plate, the tether, and the inner plate and holds them in place on the frame.

7. The security tether of claim 1, wherein the inner plate is configured to span the gap when the door is closed to restrict the inner plate from passing through the gap.

8. The security tether of claim 1, wherein:
the entryway includes a doorjamb disposed on a portion of the frame and projecting into the gap; and
the tether is compressed between the door and the doorjamb when the door is closed.

9. The security tether of claim 2, wherein the first end of the tether is held in place vertically when the tether is compressed between the door and the doorjamb.

10. The security tether of claim 1, wherein the tether is an elongate tension bearing member.

11. The security tether of claim 4, wherein the tether includes a core member comprised of woven metal.

12. The security tether of claim 5, wherein the tether further includes a sheath covering at least a portion of the core member.

13. The security tether of claim 6, wherein the sheath is comprised of a cut-resistant material.

14. The security tether of claim 7, wherein the sheath is comprised of aromatic polyamide fibers.

15. The security tether of claim 1, wherein the inner plate is a rigid plate.

16. The security tether of claim 1, further comprising a guide cooperating with the tether and disposed proximate the outer face of the door when the door is closed.

17. The security tether of claim 12, wherein the outer plate is a rigid plate.

18. The security tether of claim 10, wherein the outer plate is not fastened to the entryway.

19. The security tether of claim 1, wherein the tether extends beyond the frame a distance sufficient for the attachment member to couple with a locking device secured to an item outside the dwelling.

20. The security tether of claim 1, wherein the inner plate is not fastened to the entryway.
